(19) United States
(12) Patent Application Publication
(10) Pub. No.: US 2013/0101772 A1
(43) Pub. Date: Apr. 25, 2013

(54) THERMALLY CONDUCTIVE REINFORCING COMPOSITION, THERMALLY CONDUCTIVE REINFORCING SHEET, REINFORCING METHOD, AND REINFORCING STRUCTURE

(71) Applicants: Takuya Mase, Osaka (JP); Yoshio Terada, Osaka (JP); Midori Tojo, Osaka (JP)

(72) Inventors: Takuya Mase, Osaka (JP); Yoshio Terada, Osaka (JP); Midori Tojo, Osaka (JP)

(73) Assignee: NITTO DENKO CORPORATION, Ibaraki-shi, Osaka (JP)

(21) Appl. No.: 13/807,855

(22) PCT Filed: May 25, 2011
(86) PCT No.: PCT/JP2011/061961

§ 371 Date: Dec. 31, 2012

(30) Foreign Application Priority Data
Jul. 2, 2010 (JP) 2010-151700

(51) Int. Cl. C09K 5/00

(52) U.S. Cl. CPC C09K 5/00
USPC 428/36.8; 252/73; 252/74; 252/77

(57) ABSTRACT

A thermally conductive reinforcing composition includes a curing component, a rubber component, and thermally conductive particles.

### CROSS-REFERENCE TO RELATED APPLICATIONS

The present invention is a 35 U.S.C. 371 National Stage Entry of PCT/JP2011/061961, filed May 25, 2011, which claims priority from Japanese Patent Application No. 2010-151700, filed on Jul. 2, 2010, the contents all of which are herein incorporated by reference.

### TECHNICAL FIELD

The present invention relates to a thermally conductive reinforcing composition, a thermally conductive reinforcing sheet, a reinforcing method, and a reinforcing structure, to be specific, to a thermally conductive reinforcing composition, a thermally conductive reinforcing sheet using the thermally conductive reinforcing composition, a reinforcing method in which an object to be reinforced is reinforced by using the thermally conductive reinforcing sheet, and a reinforcing structure in which an object to be reinforced is reinforced by the reinforcing method.

### BACKGROUND ART

Conventionally, in various industrial products, it has been known that in a casing which houses a heating element, for example, a thermally conductive sheet is disposed on the surface of the casing so as to quickly thermally conduct heat generated from the heating element.

As such a thermally conductive sheet, for example, a thermally conductive sheet which contains a silicone copolymer and a thermally conductive filler has been proposed (ref: for example, the following Patent Document 1).

### PRIOR ART DOCUMENT

### Patent Document

Patent Document 1: Japanese Unexamined Patent Publication No. 2010-7039

### SUMMARY OF THE INVENTION

### Problems to be Solved by the Invention

However, there may be a case where a casing is required to have the mechanical strength in accordance with its use and purpose.

However, in the thermally conductive sheet described in the above-described Patent Document 1, there is a disadvantage that the mechanical strength of the casing cannot be sufficiently improved.

It is an object of the present invention to provide a thermally conductive reinforcing sheet which is capable of achieving both excellent thermally conductive properties and excellent reinforcing properties, a thermally conductive reinforcing composition for forming the thermally conductive reinforcing sheet, and a reinforcing structure and a reinforcing method in which both of the thermally conductive properties and the mechanical strength are improved.

### Solution to the Problems

A thermally conductive reinforcing composition of the present invention includes a curing component, a rubber component, and thermally conductive particles.

In the thermally conductive reinforcing composition of the present invention, it is preferable that the thermally conductive particles are made of aluminum hydroxide.

In the thermally conductive reinforcing composition of the present invention, it is preferable that the curing component contains an epoxy resin and a curing agent, and the curing agent is a thermally curable type.

In the thermally conductive reinforcing composition of the present invention, it is preferable that the rubber component contains a styrene synthetic rubber and/or an acrylonitrile-butadiene rubber.

A thermally conductive reinforcing sheet of the present invention includes a resin layer made of the above-described thermally conductive reinforcing composition.

In the thermally conductive reinforcing sheet of the present invention, it is preferable that the thermally conductive reinforcing sheet includes a reinforcing layer laminated on one surface of the resin layer.

A reinforcing method of the present invention includes attaching the above-described thermally conductive reinforcing sheet to an object to be reinforced to be then cured.

A reinforcing structure of the present invention is formed by attaching the above-described thermally conductive reinforcing sheet to an object to be reinforced to then cure the resin layer, wherein the object to be reinforced is a casing of an electrical/electronic device.

### Effect of the Invention

The thermally conductive reinforcing composition of the present invention includes a rubber component, a curing component, and thermally conductive particles. Therefore, according to the reinforcing structure and the reinforcing method of the present invention in which the thermally conductive reinforcing sheet of the present invention including the resin layer made of the thermally conductive reinforcing composition is used, the thermally conductive reinforcing sheet is attached to an object to be reinforced to then cure the resin layer, so that the mechanical strength of the object to be reinforced is improved and the object to be reinforced can be surely reinforced, and the thermally conductive properties of the object to be reinforced can be improved.

As a result, both of the mechanical strength and the thermally conductive properties of the object to be reinforced can be improved.

### BRIEF DESCRIPTION OF THE DRAWINGS

FIG. 1 shows process drawings for illustrating one embodiment of a method for reinforcing an object to be reinforced using a thermally conductive reinforcing sheet of the present invention:

(a) illustrating a step of preparing the thermally conductive reinforcing sheet to peel off a release film,

(b) illustrating a step of attaching the thermally conductive reinforcing sheet to the object to be reinforced, and

(c) illustrating a step of curing the thermally conductive reinforcing sheet.

FIG. 2 shows process drawings for illustrating one embodiment (an embodiment in which a thermally conductive reinforcing sheet includes a reinforcing layer only) of a method for reinforcing an object to be reinforced using the thermally conductive reinforcing sheet of the present invention:

(a) illustrating a step of preparing the thermally conductive reinforcing sheet to peel off a release film,

(b) illustrating a step of attaching the thermally conductive reinforcing sheet to the object to be reinforced, and

(c) illustrating a step of curing the thermally conductive reinforcing sheet.

### EMBODIMENT OF THE INVENTION

A thermally conductive reinforcing composition of the present invention includes a curing component, a rubber component, and thermally conductive particles.

The curing component contains, for example, an epoxy resin and a curing agent.

Examples of the epoxy resin include a bisphenol epoxy resin such as a bisphenol A epoxy resin, a hydrogenated bisphenol A epoxy resin, a bisphenol F epoxy resin, and a bisphenol S epoxy resin; a novolak epoxy resin such as a phenol novolak epoxy resin and a cresol novolak epoxy resin; a nitrogen-containing-cyclic epoxy resin such as a triglycidyl isocyanurate and a hydantoin epoxy resin; an alicyclic epoxy resin; an aliphatic epoxy resin; a glycidylether epoxy resin; a biphenyl epoxy resin; a dicyclo epoxy resin; and a naphthalene epoxy resin.

The epoxy resins can be used alone or in combination of two or more.

Preferably, a bisphenol epoxy resin is used, or more preferably, a bisphenol A epoxy resin is used.

The epoxy resin has an epoxy equivalent of, for example, 180 to 340 g/eq. and is in a liquid state or in a semi-solid state at normal temperature. The epoxy equivalent is measured and calculated in conformity with JIS K7236 (in the 2001 edition). Preferably, a combination of an epoxy resin in a liquid state at normal temperature and an epoxy resin in a semi-solid state at normal temperature is used.

The mixing ratio of the epoxy resin with respect to the curing component is, for example, 50 to 99 mass %, or preferably 75 to 95 mass %.

A curing agent is, for example, a thermally curable type which is cured by heating. Examples of the curing agent include an amine compound, an acid anhydride compound, an amide compound, a hydrazide compound, an imidazole compound, and an imidazoline compound. In addition to the above-described compounds, a phenol compound, a urea compound, and a polysulfide compound are also used.

Examples of the amine compound include ethylene diamine, propylene diamine, diethylene triamine, triethylene tetramine, or amine adducts thereof; metha phenylenediamine; diaminodiphenyl methane; and diaminodiphenyl sulfone.

Examples of the acid anhydride compound include phthalic anhydride, maleic anhydride, tetrahydrophthalic anhydride, hexahydrophthalic anhydride, methyl nadic anhydride, pyromellitic anhydride, dodecenylsuccinic anhydride, dichloro succinic anhydride, benzophenone tetracarboxylic anhydride, and chlorendic anhydride.

Examples of the amide compound include dicyandiamide and polyamide.

An example of the hydrazide compound includes adipic acid dihydrazide.

Examples of the imidazole compound include methyl imidazole, 2-ethyl-4-methyl imidazole, ethyl imidazole, isopropyl imidazole, 2,4-dimethyl imidazole, phenyl imidazole, undecyl imidazole, heptadecyl imidazole, and 2-phenyl-4-methyl imidazole.

Examples of the imidazoline compound include methyl imidazoline, 2-ethyl-4-methyl imidazoline, ethyl imidazoline, isopropyl imidazoline, 2,4-dimethyl imidazoline, phenyl imidazoline, undecyl imidazoline, heptadecyl imidazoline, and 2-phenyl-4-methyl imidazoline.

The curing agents can be used alone or in combination.

As the curing agent, preferably, in view of adhesive properties, an amide compound is used, or more preferably, dicyandiamide is used.

The mixing ratio of the curing agent with respect to 100 parts by mass of the epoxy resin is, though depending on the equivalent ratio of the curing agent to the epoxy resin to be used, 3 to 20 parts by mass, or preferably 5 to 10 parts by mass.

A curing accelerator, along with the curing agent, can be blended in the curing component as required.

Examples of the curing accelerator include an amino acid compound, a urea compound, a phosphorous compound, a quaternary ammonium salt compound, and an organic metal salt compound. Preferably, an amino acid compound is used.

The amino acid compound is an aminocarboxylic acid. To be specific, examples thereof include mono-amino-mono-carboxylic acid such as glycine, alanine, valine, leucine, isoleucine, serine, threonine, cysteine, methionine, phenylalanine, tryptophan, tyrosine, proline, cystine, and aminododecanoic acid; mono-amino-dicarboxylic acid such as glutamic acid, asparagine acid, glutamine, and asparagine; and diamino-mono-carboxylic acid such as lysine, arginine, and histidine. Preferably, mono-amino-mono-carboxylic acid is used, or more preferably, aminododecanoic acid is used.

The curing accelerators can be used alone or in combination.

The mixing ratio of the curing accelerator with respect to 100 parts by mass of the epoxy resin is 3 to 20 parts by mass, or preferably 4 to 10 parts by mass.

The mixing ratio of the curing component with respect to the thermally conductive reinforcing composition is, for example, 1 to 50 mass %, or preferably 10 to 40 mass %.

The rubber component contains, for example, a synthetic rubber such as a styrene synthetic rubber, an acrylonitrile-butadiene rubber, and/or a low-polarity rubber excluding the styrene synthetic rubber and the acrylonitrile-butadiene rubber.

The styrene synthetic rubber is a synthetic rubber in which at least styrene, as a material monomer, is used. Examples of the styrene synthetic rubber include a styrene-butadiene rubber such as a styrene-butadiene random copolymer (SBR), a styrene-butadiene-styrene block copolymer (SBS), a styrene-ethylene-butadiene copolymer (SEB), and a styrene-ethylene-butadiene-styrene block copolymer (SEBS) and a styrene-isoprene rubber such as a styrene-isoprene-styrene block copolymer (SIS).

Preferably, a styrene-butadiene rubber is used, or more preferably, in view of reinforcing properties and adhesive properties to an oily surface, a styrene-butadiene random copolymer is used.

The content of the styrene in the styrene synthetic rubber is, for example, 50 mass % or less, or preferably 35 mass % or less. When the content of the styrene exceeds the above-described range, the adhesive properties at low temperature may be reduced.

The number average molecular weight of the styrene synthetic rubber by GPC measurement (calibrated with standard polystyrene) is, for example, 30000 or more, or preferably 50000 to 100000. When the number average molecular weight of the styrene synthetic rubber is below the above-described range, the adhesive force, among all, the adhesive properties with respect to a steel plate having an oily surface may be reduced.

The Mooney viscosity of the styrene synthetic rubber is, for example, 20 to 60 (ML1+4, at 100° C.), or preferably 30 to 50 (ML1+4, at 100° C.).

The styrene synthetic rubbers can be used alone or in combination.

The mixing ratio of the styrene synthetic rubber with respect to the rubber component is, for example, 5 to 60 mass %, or preferably 10 to 50 mass %.

The acrylonitrile-butadiene rubber is blended so as to improve the compatibility of the epoxy resin with the styrene synthetic rubber. To be specific, the acrylonitrile-butadiene rubber is an acrylonitrile-butadiene (random) copolymer (NBR) and to be more specific, is a synthetic rubber obtained by emulsion polymerization of acrylonitrile with butadiene. Examples of the acrylonitrile-butadiene rubber include a rubber in which a carboxyl group is introduced and a rubber which is partially cross-linked by sulfur, a metal oxide, or the like.

The acrylonitrile-butadiene rubber is in a solid state at normal temperature and has an excellent compatibility with the epoxy resin. Therefore, by allowing the acrylonitrile-butadiene rubber to be contained, the pressure-sensitive adhesive properties, the handling ability, and furthermore, the reinforcing properties can be improved in a wide range of temperature region around normal temperature.

The content of the acrylonitrile in the acrylonitrile-butadiene rubber is, for example, 10 to 50 mass %, or preferably 20 to 40 mass %.

The Mooney viscosity of the acrylonitrile-butadiene rubber is, for example, 25 (ML1+4, at 100° C.) or more, or preferably 50 (ML1+4, at 100° C.) or more.

The mixing ratio of the acrylonitrile-butadiene rubber with respect to the rubber component is, for example, 1 to 45 mass %, or preferably 5 to 20 mass %. When the mixing proportion of the acrylonitrile-butadiene rubber is below the above-described range, the adhesive properties may be reduced. On the other hand, when the mixing proportion of the acrylonitrile-butadiene rubber exceeds the above-described range, the reinforcing properties may be reduced.

The low-polarity rubber is a synthetic rubber which does not contain either a polar group such as a nitrile group or an aryl group such as a phenyl group. To be specific, examples of the low-polarity rubber include a butadiene rubber and a polybutene rubber. The low-polarity rubber is in a solid state, a semi-solid state, or a liquid state. The low-polarity rubbers can be used alone or in combination and the mixing ratio of the low-polarity rubber with respect to the rubber component is, for example, 10 mass % or less.

The above-described synthetic rubbers can be used alone or in combination of two or more.

As the synthetic rubber, preferably, a styrene synthetic rubber and/or an acrylonitrile-butadiene rubber are/is used, or more preferably, in view of further improving the reinforcing properties, a combination of a styrene synthetic rubber and an acrylonitrile-butadiene rubber is used.

When the styrene synthetic rubber and the acrylonitrile-butadiene rubber are used in combination, the mixing ratio of the styrene synthetic rubber and the acrylonitrile-butadiene rubber is, by mass basis, for example, 5/95 to 95/5, or preferably 10/90 to 90/10.

A cross-linking agent, along with the synthetic rubber, can be blended in the rubber component as required.

The cross-linking agent is a rubber cross-linking agent (a vulcanizing agent), that is, a cross-linking agent which is capable of cross-linking a styrene synthetic rubber and/or an acrylonitrile-butadiene rubber. Examples thereof include sulfur (pulverized sulfur, insoluble sulfur); an sulfur compound; selenium; magnesium oxide; lead monoxide; organic peroxide (for example, dicumyl peroxide, 1,1-di-tert-butyl peroxy-3,3,5-trimethylcyclohexane, 2,5-dimethyl-2,5-di-tert-butyl peroxy hexane, 2,5-dimethyl-2,5-di-tert-butyl peroxy hexyne, 1,3-bis(tert-butyl peroxy isopropyl)benzene, tert-butyl peroxy ketone, and tert-butyl peroxy benzoate); polyamine; oxime (for example, p-quinone dioxime, p,p′-dibenzoyl quinone dioxime, and the like); a nitroso compound (for example, p-dinitrosobenzine and the like); a resin (for example, an alkylphenol-formaldehyde resin, a melamine-formaldehyde condensate, and the like); and ammonium salt (for example, ammonium benzoate and the like).

The cross-linking agents can be used alone or in combination. In view of curing properties and reinforcing properties, preferably, sulfur is used.

The mixing ratio of the cross-linking agent with respect to 100 parts by mass of the synthetic rubber is, for example, 20 to 100 parts by mass, or preferably 25 to 80 parts by mass. When the mixing proportion of the cross-linking agent is below the above-described range, the reinforcing properties may be reduced. On the other hand, when the mixing proportion of the cross-linking agent exceeds the above-described range, there may be a case where the adhesive properties are reduced, so that a cost disadvantage occurs.

A cross-linking accelerator can be used in combination with the cross-linking agent as required.

Examples of the cross-linking accelerator include a sulfide compound (for example, di-2-benzothiazolyl disulfide and the like), a dithiocarbamic acid compound, a thiazole compound, a guanidine compound, a sulfenamide compound, a thiuram compound, a xanthate compound, an aldehyde ammonia compound, an aldehyde amine compound, a thiourea compound, and zinc oxide.

The cross-linking accelerators can be used alone or in combination.

As the cross-linking accelerator, preferably, a sulfide compound is used.

The mixing ratio of the cross-linking accelerator with respect to 100 parts by mass of the synthetic rubber is, for example, 10 to 40 parts my mass, or preferably 20 to 30 parts by mass.

The mixing ratio of the rubber component with respect to the thermally conductive reinforcing composition is, for example, 1 to 50 mass %, or preferably 10 to 40 mass %.

Examples of a thermally conductive material which forms the thermally conductive particles include an inorganic material and an organic material. Preferably, an inorganic material is used.

Examples of the inorganic material include nitride such as boron nitride, aluminum nitride, silicon nitride, and gallium nitride; hydroxide such as aluminum hydroxide and magnesium hydroxide; oxide such as silicon oxide (for example, silica and the like), aluminum oxide (for example, alumina and the like), titanium oxide (for example, titania and the like), zinc oxide, tin oxide (for example, including doped tin oxide such as antimony doped tin oxide), copper oxide, and nickel oxide; carbide such as silicon carbide; carbonate such as calcium carbonate; metal acid salt such as titanate including barium titanate and potassium titanate; and a metal such as copper, silver, gold, nickel, aluminum, and platinum.

As the thermally conductive material, preferably, nitride, hydroxide, and oxide are used, more preferably, in view of obtaining further excellent thermally conductive properties, or furthermore, in view of obtaining electrical insulating properties, boron nitride, aluminum hydroxide, and aluminum oxide are used, or particularly preferably, aluminum hydroxide is used.

These thermally conductive materials can be used alone or in combination of two or more.

The shape of each of the thermally conductive particles is not particularly limited. Examples of the shape thereof include a bulk shape, a needle shape, a plate shape, a layer shape, and a tube shape.

As the shape of each of the thermally conductive particles, preferably, a bulk shape, a needle shape, and a plate shape are used.

To be specific, examples of the bulk shape include a sphere shape, a rectangular parallelepiped shape, and a pulverized shape.

The size of each of the thermally conductive particles is not particularly limited. In the case of a bulk shape (a sphere shape), the average particle size of the first particle is, for example, 0.1 to 1000 μm, preferably 1 to 100 μm, or more preferably 2 to 50 μm.

The average particle size of each of the thermally conductive particles is an average particle size based on volume obtained by particle size distribution measurement by a laser scattering method. To be specific, the average particle size of each of the thermally conductive particles is obtained by measuring a D50 value (a median size) with a laser scattering particle size analyzer.

When the average particle size of each of the thermally conductive particles is not more than 1000 μm, in the case where the thickness of the reinforcing layer is formed to be below 1000 μm, it can be prevented that the size of each of the thermally conductive particles which forms a bulk exceeds the thickness of the reinforcing layer, causing the occurrence of unevenness in the thickness of the reinforcing layer.

On the other hand, when the average particle size of each of the thermally conductive particles exceeds the above-described range, the average particle size of each of the thermally conductive particles exceeds the desired thickness (described later) of the resin layer, so that the thermally conductive particles may be non-uniformly (dispersedly) dispersed in the pressure-sensitive adhesive composition.

When the shape of each of the thermally conductive particles is a needle shape or a plate shape, the maximum length of the first particle is, for example, 0.1 to 1000 μm, preferably 1 to 100 μm, or more preferably 2 to 50 μm.

The average of the maximum length of each of the thermally conductive particles is an average particle size based on volume obtained by particle size distribution measurement by a laser scattering method. To be specific, the average of the maximum length of each of the thermally conductive particles is obtained by measuring a D50 value (a median size) with a laser scattering particle size analyzer.

When the maximum length of each of the thermally conductive particles is not more than 1000 μm, in the case where the thickness of the reinforcing layer is formed to be below 1000 μm, it can be prevented that the length of each of the thermally conductive particles exceeds the thickness of the reinforcing layer, causing the occurrence of unevenness in the thickness of the reinforcing layer.

On the other hand, when the size of each of the thermally conductive particles exceeds the above-described range, the thermally conductive particles easily aggregate and the handling thereof may become difficult.

The aspect ratio of each of the thermally conductive particles, to be specific, the length of the long axis/the length of the short axis when the shape thereof is a needle shape or the diagonal length/the thickness when the shape thereof is a plate shape, is, for example, 10000 or less, or preferably 10 to 1000.

The thermal conductivity of the thermally conductive particles is, for example, 1 W/m·K or more, preferably 2 W/m·K or more, or more preferably 3 W/m·K or more, and is usually 1000 W/m·K or less. The thermal conductivity of the thermally conductive particles is measured by, for example, a hot wire method (a probe method).

A commercially available product can be used as the thermally conductive particles. Examples of the commercially available product include in the boron nitride particles, HP-40 (manufactured by MIZUSHIMA FERROALLOY CO., LTD.) and PT620 (manufactured by Momentive Performance Materials Inc.); in the aluminum hydroxide particles, a HIGILITE series (manufactured by SHOWA DENKO K.K.) such as HIGILITE H-10, HIGILITE H-32, HIGILITE H-42, and HIGILITE H-100-ME; and in the aluminum oxide particles, AS-50 (manufactured by SHOWA DENKO K.K.). Also, examples of the commercially available product of the thermally conductive particles include in the magnesium hydroxide particles, KISUMA 5A (manufactured by Kyowa Chemical Industry Co., Ltd.); in the antimony doped tin oxide particles, an SN-series (manufactured by ISHIHARA SANGYO KAISHA, LTD.) such as SN-100S, SN-100P, and SN-100D (an aqueous dispersion product); and in the titanium oxide particles, a TTO series (manufactured by ISHIHARA SANGYO KAISHA, LTD.) such as TTO-50 and TTO-51 and a ZnO series (manufactured by SUMITOMO OSAKA CEMENT Co., Ltd.) such as ZnO-310, ZnO-350, and ZnO-410.

The thermally conductive particles can be used alone or in combination of two or more.

The mixing ratio of the thermally conductive particles with respect to 100 parts by mass of the sum total of the curing component and the rubber component is, for example, 10 to 1000 parts by mass, preferably 50 to 500 parts by mass, or more preferably 100 to 400 parts by mass. When the mixing proportion of the thermally conductive particles exceeds the above-described range, there may be a case where the flexibility of a resin layer (described later) is reduced, so that the adhesive force is reduced. On the other hand, when the mixing proportion of the thermally conductive particles is below the above-described range, the thermally conductive properties may not be sufficiently improved.

In addition to the above-described component, an additive can be also added to the thermally conductive reinforcing composition. Examples of the additive include fillers, silane coupling agents, tackifiers, oxidation inhibitors, softeners (for example, naphthenic oil, paraffinic oil, and the like), thixotropic agents (for example, montmorillonite and the like), lubricants (for example, stearic acid and the like), pigments, antiscorching agents, stabilizers, antioxidants, ultraviolet absorbers, colorants, fungicides, flame retardants, and foaming agents.

The filler is particles excluding the above-described thermally conductive particles and to be specific, is thermally insulating particles.

Examples of the thermally insulating particles include calcium carbonate (for example, heavy calcium carbonate, light calcium carbonate, Hakuenka, and the like), magnesium silicate (for example, talc and the like), bentonite (for example, organic bentonite and the like), clay, aluminum silicate, and carbon black. The fillers can be used alone or in combination. Preferably, carbon black is used.

The thermal conductivity of the filler is usually below 1.0 W/m·K.

The silane coupling agent is blended as required so as to improve the adhesive properties, the durability, and the affinity (the affinity between the curing component and the rubber component, and the thermally conductive particles).

The silane coupling agent is not particularly limited. Examples thereof include an epoxy group-containing silane coupling agent such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; an amino group-containing silane coupling agent such as 3-aminopropyltrimethoxysilane, N2-(aminoethyl)-3-aminopropylmethyldimethoxysilane, and 3-triethoxysilyl-N-(1,3-dimethyl-butylidene)propylamine; (meth)acrylic group-containing silane coupling agent such as 3-acryloxypropyltrimethoxysilane and 3-methacryloxypropyltriethoxysilane; and an isocyanate group-containing silane coupling agent such as 3-isocyanatepropyltriethoxysilane. The silane coupling agents can be used alone or in combination.

The tackifier is blended as required so as to improve the adhesiveness to an object to be reinforced or to improve the reinforcing properties.

Examples of the tackifier include a rosin resin, a terpene resin, a coumarone-indene resin, a petroleum resin, and a phenol resin.

Examples of the oxidation inhibitor include amine-ketones, aromatic secondary amines, phenols, benzimidazoles (for example, 2-mercaptobenzimidazole and the like), thioureas, and phosphorous acids.

The addition ratio of the additive with respect to 100 parts by mass of the sum total of the curing component and the rubber component is as follows: among all, in the case of the filler, for example, 1 to 200 parts by mass; in the case of the silane coupling agent, for example, 0.01 to 10 parts by mass, or preferably 0.02 to 5 parts by mass; and in the case of the oxidation inhibitor, for example, 0.1 to 5 parts by mass.

The above-described curing components, rubber components, and thermally conductive particles (and the additive blended as required) are blended at the above-described mixing proportion to be stirred and mixed, so that the thermally conductive reinforcing composition can be prepared. In the stirring and mixing, each of the components is kneaded with, for example, a known kneader such as a mixing roll, a pressurized kneader, an extruder, or the like.

To be more specific, first, the epoxy resin, the styrene synthetic rubber, the acrylonitrile-butadiene rubber, and the thermally conductive particles are kneaded with a kneader heated at, for example, 100 to 150° C. in advance. Thereafter, the obtained product is cooled at, for example, 40 to 95° C. and then, the curing agent, the curing accelerator, the cross-linking agent, and the cross-linking accelerator are added thereto to be kneaded with a kneader at 40 to 95° C., so that the thermally conductive reinforcing composition is prepared as a kneaded product.

The flow tester viscosity (at 60° C., a load of 20 kg) of the kneaded product obtained in this way is, for example, 5×10 to 5×10⁴ Pa·s, or preferably 1×10² to 5×10³ Pa·s.

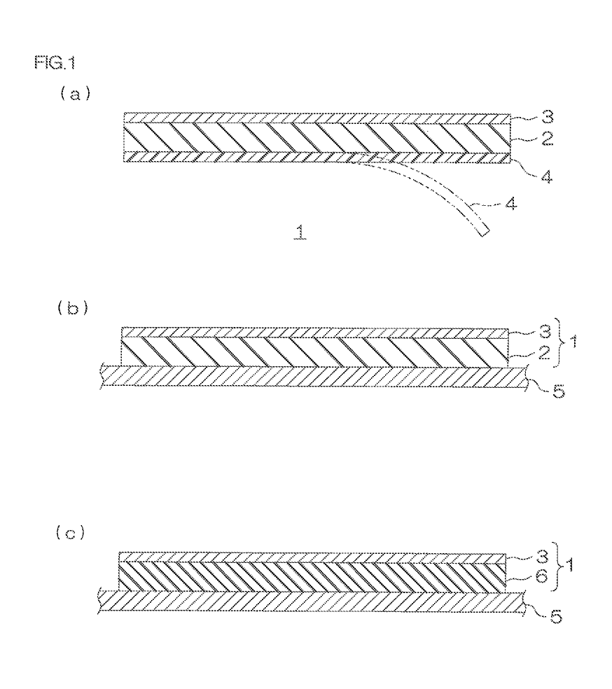

FIG. 1 shows process drawings for illustrating one embodiment of a method for reinforcing an object to be reinforced using a thermally conductive reinforcing sheet of the present invention.

Next, one embodiment of a reinforcing method of the present invention is described with reference to FIG. 1.

First, in this method, a thermally conductive reinforcing sheet 1 is prepared.

In FIG. 1 (a), the thermally conductive reinforcing sheet 1 includes a resin layer 2 and a reinforcing layer 3 laminated on the surface of the resin layer 2.

The resin layer 2 is made of the above-described thermally conductive reinforcing composition and is formed into a sheet shape.

The thickness of the resin layer 2 is, for example, 0.4 to 3 mm, or preferably 0.5 to 2.5 mm.

The reinforcing layer 3 is formed as a constraining layer which imparts toughness to the resin layer 2 after curing (that is, a cured resin layer 6, ref: FIG. 1 (c)) and is formed into a sheet shape. The reinforcing layer 3 is formed of a material which is light in weight, has a thin film, and is capable of being integrally brought into close contact with the cured resin layer 6. To be specific, examples of the material include a glass cloth, a resin impregnated glass cloth, a synthetic resin non-woven fabric, a metal foil, and a carbon fiber.

The glass cloth is cloth formed from a glass fiber and a known glass cloth is used.

The resin impregnated glass cloth is obtained by performing an impregnation treatment of a synthetic resin such as a thermosetting resin and a thermoplastic resin into the above-described glass cloth and a known resin impregnated glass cloth is used. Examples of the thermosetting resin include an epoxy resin, a urethane resin, a melamine resin, and a phenol resin. Examples of the thermoplastic resin include a vinyl acetate resin, an ethylene-vinyl acetate copolymer (EVA), a vinyl chloride resin, and an EVA-vinyl chloride resin copolymer. A mixed resin of the above-described thermosetting resin with the above-described thermoplastic resin (for example, a melamine resin with a vinyl acetate resin) is also used.

An example of the metal foil includes a known metal foil such as an aluminum foil and a steel foil.

Of these, in view of mass, adhesiveness, strength, and cost, preferably, a glass cloth and a resin impregnated glass cloth are used.

The thickness of the reinforcing layer 3 is, for example, 0.05 to 2 mm, or preferably 0.1 to 1.0 mm

In order to prepare the thermally conductive reinforcing sheet 1, the above-described kneaded product of the thermally conductive reinforcing composition is laminated on the surface of the reinforcing layer 3 in a sheet shape. That is, the above-described kneaded product of the thermally conductive reinforcing composition is molded into a sheet shape by, for example, a known molding method such as a press molding, a calender molding, or an extrusion molding to form the resin layer 2. Thereafter, the resin layer 2 is attached to the reinforcing layer 3.

The total thickness of the resin layer 2 and the reinforcing layer 3 is, for example, 0.4 to 5 mm, or preferably 0.6 to 3.5 mm.

In this way, the thermally conductive reinforcing sheet 1 is obtained.

In the obtained thermally conductive reinforcing sheet 1, a release film (a separator) 4 is attached to the surface of the resin layer 2 as required.

An example of the release film 4 includes a known release film such as a synthetic resin film including a polyethylene film, a polypropylene film, and a polyethylene terephthalate film.

Next, as shown in FIG. 1 (b), the thermally conductive reinforcing sheet 1 is attached to an object 5 to be reinforced and thereafter, as shown in FIG. 1 (c), the object 5 to be reinforced is reinforced by curing the resin layer 2.

The object 5 to be reinforced is not particularly limited as long as it is a member which requires reinforcement in various industrial products. An example thereof includes a casing which houses a heating element. To be specific, an example thereof includes a casing of an electrical/electronic device. To be more specific, examples thereof include a casing of a household electric appliance such as a refrigerator and an air conditioner's outdoor unit; a casing of an electrical device such as a motor; and a casing of an electronic device such as an image display device including a liquid crystal display and a plasma display and a mobile device including a notebook personal computer.

A material which forms the casing is not particularly limited. Examples of the material include a metal material such as aluminum, stainless steel, iron, copper, gold, silver, chromium, nickel, or alloys thereof and a resin material such as a known synthetic resin.

As the object 5 to be reinforced, for example, various steel plates are used, or preferably, a steel plate for a vehicle or the like is used.

In order to reinforce the object 5 to be reinforced by the thermally conductive reinforcing sheet 1, first, as shown by a phantom line in FIG. 1 (a), the release film 4 is peeled from the surface of the resin layer 2. Next, as shown in FIG. 1 (b), the surface of the resin layer 2 is attached to the object 5 to be reinforced and thereafter, as shown in FIG. 1 (c), the object 5 to be reinforced is heated at a predetermined temperature, so that the resin layer 2 is cured to form the cured resin layer 6.

The above-described heating of the object 5 to be reinforced is performed by putting the object 5 to be reinforced to which the thermally conductive reinforcing sheet 1 is attached into a drying oven in a drying process of production of the object 5 to be reinforced.

Alternatively, when the drying process is not performed in the production of the object 5 to be reinforced, the thermally conductive reinforcing sheet 1 only is heated by using a partial heating device such as a heat gun instead of the above-described inputting into the drying oven.

Alternatively, using the above-described heating device, the object 5 to be reinforced only, or furthermore, both of the thermally conductive reinforcing sheet 1 and the object 5 to be reinforced can be heated. When the object 5 to be reinforced only is heated, heat of the heating device is thermally conducted to the thermally conductive reinforcing sheet 1.

The heating temperature is, for example, 120 to 250° C., or preferably 160 to 210° C.

The thermally conductive reinforcing sheet 1 is attached to the object 5 to be reinforced and the thermally conductive reinforcing sheet 1 and/or the object 5 to be reinforced are/is heated, so that the resin layer 2 is cured.

In this way, the reinforcing structure in which the object 5 to be reinforced is reinforced by the thermally conductive reinforcing sheet 1 is formed.

In the reinforcing structure, the bending strength of the thermally conductive reinforcing sheet 1 is, for example, 10 N or more, or preferably 15 N or more, and is usually 100 N or less.

The bending strength of the thermally conductive reinforcing sheet 1 is measured in the following manner.

That is, first, with respect to an aluminum board having a size of 150 mm×25 mm and a thickness of 1.0 mm, the resin layer 2 in the thermally conductive reinforcing sheet 1 having the same size as that of the aluminum board is attached to be then heated at 160° C. for 20 minutes and the resin layer 2 is cured to form the cured resin layer 6, so that a test piece is fabricated. Thereafter, in a state where the aluminum board faces upwardly, the test piece is supported with a span of 100 mm and a testing bar is lowered from above to the center in the longitudinal direction thereof at a rate of 1 mm/min. The strength at the time when the cured resin layer 6 is displaced by 1 mm after allowing the testing bar to come into contact with the aluminum board is measured as a bending strength (N).

The bending strength at a displacement of 1 mm of the aluminum board having a thickness of 1.0 mm only is usually about 7.0 N.

When the bending strength of the thermally conductive reinforcing sheet 1 is below the above-described range, the object 5 to be reinforced may not be sufficiently reinforced.

The thermal conductivity of the cured resin layer 6 is, for example, 0.10 W/m·K or more, or preferably 0.20 W/m·K or more, and is usually 10 W/m·K or less.

The thermal conductivity of the cured resin layer 6 is calculated by the following formula.

Thermal conductivity=(thermal diffusivity)×(heat capacity per unit volume of the cured resin layer 6)

The thermal diffusivity is measured with a thermal diffusivity measurement device. The heat capacity per unit volume of the cured resin layer 6 is measured with a differential scanning calorimetry (DSC).

The thermal conductivity of the cured resin layer 6 is substantially the same as that of the resin layer 2.

When the thermal conductivity of the cured resin layer 6 is within the above-described range, the thermally conductive properties of the object to be reinforced can be improved.

The thermally conductive reinforcing composition of the present invention includes the rubber component, the curing component, and the thermally conductive particles. Therefore, according to the reinforcing method in which the thermally conductive reinforcing sheet 1 including the resin layer 2 made of the thermally conductive reinforcing composition is used, the thermally conductive reinforcing sheet 1 is attached to the object 5 to be reinforced to then cure the resin layer 2, so that the mechanical strength of the object 5 to be reinforced is improved and the object 5 to be reinforced can be surely reinforced, and the thermally conductive properties of the object 5 to be reinforced can be improved.

As a result, both of the mechanical strength and the thermally conductive properties of the object 5 to be reinforced can be improved.

The thermally conductive reinforcing sheet 1 further includes the reinforcing layer 3 which supports the resin layer 2, so that the mechanical strength of the object 5 to be reinforced can be further improved.

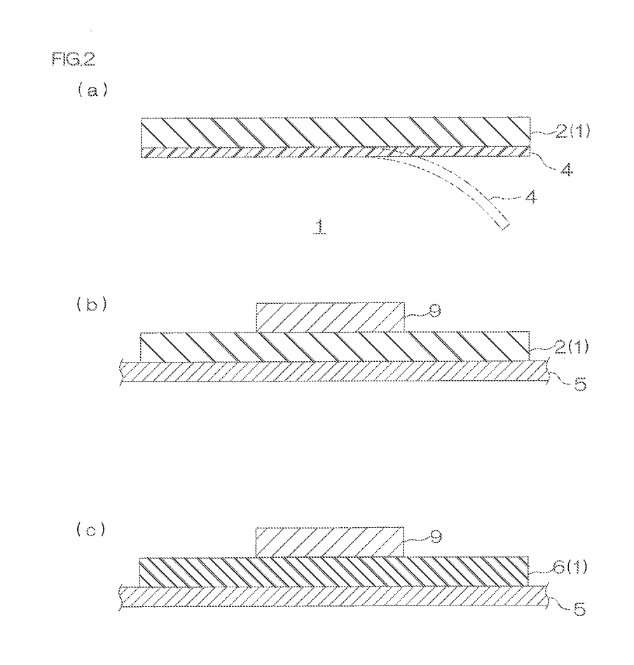

On the other hand, in the above-described description of FIG. 1, the reinforcing layer 3 is included in the thermally conductive reinforcing sheet 1. Alternatively, for example, as shown in FIG. 2 (a), the thermally conductive reinforcing sheet 1 can be formed of the resin layer 2 only without including the reinforcing layer 3.

When the thermally conductive reinforcing sheet 1 is formed of the resin layer 2 only, as shown in FIG. 2 (b), a component 9 which is housed inside of the object 5 to be reinforced and generates heat is directly brought into contact with the resin layer 2 and thereafter, the resin layer 2 is thermally cured, so that the component 9 can be adhered to the cured resin layer 6. Therefore, when the component 9 generates heat, the heat can be quickly thermally conducted (dissipated) to the object 5 to be reinforced via the cured resin layer 6.

### EXAMPLES

The present invention will now be described in more detail by way of Examples and Comparative Examples. However, the present invention is not limited to the following Examples and Comparative Examples.

### Examples 1 and 2

Thermally conductive reinforcing compositions were prepared by kneading components with a mixing roll in conformity with the mixing formulation shown in Table 1.

That is, first, epoxy resins 1 and 2, a styrene synthetic rubber, an acrylonitrile-butadiene rubber, aluminum hydroxide particles, and carbon black were kneaded with a mixing roll heated at 120° C. in advance and a kneaded product was prepared. Next, the obtained kneaded product was cooled to 50 to 80° C. and then, a curing agent, a curing accelerator, a cross-linking agent, and a cross-linking accelerator were blended into the obtained kneaded product to be subsequently kneaded at 50 to 80° C. with a mixing roll, so that the thermally conductive reinforcing composition was prepared.

Next, the prepared thermally conductive reinforcing composition was extended by applying pressure into a sheet shape with a pressing molding machine, so that a resin layer having a thickness of 0.6 mm was formed.

Thereafter, a reinforcing layer made of a glass cloth having a thickness of 0.2 mm was attached to the surface of the resin layer and subsequently, a release film was laminated on the back surface (the opposite surface with respect to the surface to which the reinforcing layer was attached) of the resin layer, so that a thermally conductive reinforcing sheet was fabricated.

### Comparative Examples 1 and 2

Each of the thermally conductive reinforcing sheets was fabricated in the same manner as in Examples 1 and 2, except that silicone resin-based thermally conductive materials (sheets) 1 and 2 were used as they were as resin layers.

(Evaluation)

1) Reinforcing Properties

A. Reinforcing Properties of Thermally Conductive Reinforcing Sheets in Examples 1 and 2

Each of the thermally conductive reinforcing sheets of Examples 1 and 2 was trimmed into a size of 150 mm×25 mm. The release film was peeled from the resin layer and then, the reinforcing layer was attached to an aluminum board having a size of 150 mm×25 mm×1.0 mm (trade name: “A6061”, manufactured by Nippon Testpanel Co., Ltd.) under an atmosphere of 20° C. to be thereafter heated at 160° C. for 20 minutes, so that the resin layer was cured to form the cured resin layer. In this manner, a test piece was fabricated.

Thereafter, in a state where the aluminum board faced upwardly, the test piece was supported with a span of 100 mm and a testing bar was lowered from above to the center in the longitudinal direction thereof at a rate of 1 mm/min. The bending strength (N) at the time when the cured resin layer was displaced by 1 mm after allowing the testing bar to come into contact with the aluminum board was measured, so that the reinforcing properties of the thermally conductive reinforcing sheet was evaluated. The results are shown in Table 1.

B. Reinforcing Properties of Thermally Conductive Reinforcing Sheets in Comparative Examples 1 and 2

The thermally conductive reinforcing sheets of Comparative Examples 1 and 2 were subjected to the same operation as that described above. However, by heating at 160° C., the resin layers were not cured (that is, the cured resin layers were not formed), so that the reinforcing properties of the thermally conductive reinforcing sheets including the resin layers were evaluated as they were.

C. Reinforcing Properties of Aluminum Board

The aluminum board having a thickness of 1.0 mm only in which the thermally conductive sheet was not included was also measured in the same manner as that described above. The strength of the aluminum board at a displacement of 1 mm was 7.0 (N).

2) Thermal Conductivity

A. Thermal Conductivity of Examples 1 and 2

The kneaded products of the thermally conductive reinforcing compositions of Examples 1 and 2 were heated at 160° C. for 20 minutes to form the cured resin layers. The thermal diffusivity and the heat capacity per unit volume of each of the cured resin layers were measured and the thermal conductivity of each of the cured resin layers was calculated by multiplying the obtained values.

The thermal diffusivity was measured with a thermal diffusivity and thermal conductivity measurement device (trade name: “ai-Phase Mobile”, manufactured by ai-Phase Co., Ltd.) and the heat capacity was measured with a differential scanning calorimetry (DSC). The results are shown in Table 1.

B. Thermal Conductivity of Comparative Examples 1 and 2

The thermal diffusivity and the heat capacity per unit volume of each of the resin layers of Comparative Examples 1 and 2 were measured with the same devices as those described above and the thermal conductivity of each of the resin layers was calculated by multiplying the obtained values. The results are shown in Table 1.

TABLE 1

| | Ex. Comp. Ex. | | Ex. 1 | Ex. 2 | Comp. Ex. 1 | Comp. Ex. 2 |
|---|---|---|---|---|---|---|
| Mixing Formulation | Curing Component | Epoxy Resin 1 | 50 | 50 | — | — |
| of Thermally | | Epoxy Resin 2 | 10 | 10 | | |
| Conductive | | Curing Agent | 5 | 5 | | |
| Reinforcing | | Curing Accelerator | 3 | 3 | | |
| Composition (Parts | Rubber Component | Styrene Synthetic Rubber | 40 | 40 | | |
| by Mass) | | Acrylonitrile-Butadiene Rubber | 5 | 5 | | |
| | | Cross-Linking Agent | 35 | 35 | | |
| | | Cross-Linking Accelerator | 10 | 10 | | |
| | Thermally | Aluminum Hydroxide Particles | 165 | 247.5 | | |
| | Conductive Particles | | | | | |
| | Filler (Thermally | Carbon Black | 3 | 3 | | |
| | Insulating Particles) | | | | | |
| | Silicone Resin-Based Thermally Conductive Material 1 | | — | — | 100 | — |
| | Silicone Resin-Based Thermally Conductive Material 2 | | — | — | — | 100 |
| Evaluation | Reinforcing | Strength (N) at Time of Displacement | 19.9 | 22.6 | 6.2 | 5.8 |
| | Properties of | of 1 mm | | | | |
| | Thermally | | | | | |
| | Conductive | | | | | |
| | Reinforcing Sheet | | | | | |
| | Thermally | Thermal Conductivity (W/m · K) | 0.22 | 0.32 | 1.0*¹ | 1.0*¹ |
| | Conductive | | | | | |
| | Properties of Cured | | | | | |
| | Resin Layer | | | | | |

*1: Thermal conductivity of resin layer

In Table 1, values for the components in the row of thermally conductive reinforcing composition show number of blended parts by mass.

For the components shown in Table 1, details are given in the following.

Epoxy Resin 1: trade name “JER 834”, a bisphenol A epoxy resin, an epoxy equivalent of 230 to 270 g/eq., a semi-solid state (at normal temperature), manufactured by Japan Epoxy Resins Co., Ltd.

Epoxy Resin 2: trade name “Adekaresin EP4080E”, a bisphenol A epoxy resin, an epoxy equivalent of 215 g/eq., a liquid state (at normal temperature), manufactured by ADEKA CORPORATION

Curing Agent: trade name “DDA50”, dicyandiamide, a thermally curable type, manufactured by PTI JAPAN LTD.

Curing Accelerator: trade name “K-37Y”, an amino acid compound (aminododecanoic acid), manufactured by PTI JAPAN LTD.

Styrene Synthetic Rubber: trade name “Tufdene”, a styrene-butadiene random copolymer, a number average molecular weight of 90000, a content of styrene of 25 mass %, Mooney Viscosity of 35 (ML1+4, at 100° C.), manufactured by Asahi Kasei Corporation

Acrylonitrile-Butadiene Rubber: trade name “Nipol 1052J”, a content of acrylonitrile of 33.5 mass %, Mooney Viscosity of 77.5 (ML1+4, at 100° C.), a solid state (at normal temperature), manufactured by ZEON CORPORATION

Cross-Linking Agent: pulverized sulfur

Cross-Linking Accelerator: trade name “NOCCELER DM”, a thiazole compound (di-2-benzothiazolyl disulfide), manufactured by OUCHI SHINKO CHEMICAL INDUSTRIAL CO., LTD.

Aluminum Hydroxide Particles: trade name “HIGILITE H-32”, an average particle size: 8 nm, a bulk shape, a thermal conductivity of 4.5 W/m·K, manufactured by SHOWA DENKO K.K.

Carbon Black: trade name “Asahi #50”, thermally insulating particles (filler), an average particle size of 70 nm, a bulk shape, manufactured by ASAHI CARBON CO., LTD.

Silicone Resin-Based Thermally Conductive Material 1: trade name “TC-100SP-1.7”, a sheet shape, a thickness of 1.0 mm, manufactured by Shin-Etsu Chemical Co., Ltd.

Silicone Resin-Based Thermally Conductive Material 2: trade name “TC-100THS”, a sheet shape, a thickness of 1.0 mm, manufactured by Shin-Etsu Chemical Co., Ltd.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The thermally conductive reinforcing composition, the thermally conductive reinforcing sheet, the reinforcing method, and the reinforcing structure are used in various industrial products which require the heat dissipating properties and the reinforcing properties such as household electric appliances, electrical devices, image display devices, electronic devices, and vehicles.

1. A thermally conductive reinforcing composition comprising:
a curing component, a rubber component, and thermally conductive particles.

2. The thermally conductive reinforcing composition according to claim 1, wherein
the thermally conductive particles are made of aluminum hydroxide.

3. The thermally conductive reinforcing composition according to claim 1, wherein
the curing component contains an epoxy resin and a curing agent, and
the curing agent is a thermally curable type.

4. The thermally conductive reinforcing composition according to claim 1, wherein
the rubber component contains a styrene synthetic rubber and/or an acrylonitrile-butadiene rubber.

5. A thermally conductive reinforcing sheet comprising:
a resin layer made of a thermally conductive reinforcing composition, wherein
the thermally conductive reinforcing composition comprises:
a curing component, a rubber component, and thermally conductive particles.

6. The thermally conductive reinforcing sheet according to claim 5, wherein
the thermally conductive reinforcing sheet includes a reinforcing layer laminated on one surface of the resin layer.

7. A reinforcing method comprising:
attaching a thermally conductive reinforcing sheet to an object to be reinforced to be then cured, wherein
the thermally conductive reinforcing sheet comprises:
a resin layer made of a thermally conductive reinforcing composition, and
the thermally conductive reinforcing composition comprises:
a curing component, a rubber component, and thermally conductive particles.

8. A reinforcing structure formed by attaching a thermally conductive reinforcing sheet to an object to be reinforced to then cure the resin layer, wherein
the object to be reinforced is a casing of an electrical/electronic device, and the thermally conductive reinforcing sheet comprises:
a resin layer made of a thermally conductive reinforcing composition, and
the thermally conductive reinforcing composition comprises:
a curing component, a rubber component, and thermally conductive particles.
